(19) United States
(12) Patent Application Publication
(10) Pub. No.: US 2026/0084322 A1
(43) Pub. Date: Mar. 26, 2026

(54) AUTOMATED MECHANICAL GRIPPER WITH UNIVERSAL GRIPPING

(71) Applicant: INTERNATIONAL BUSINESS MACHINES CORPORATION, ARMONK, NY (US)

(72) Inventors: Joseph Scaglione, Poughkeepsie, NY (US); RYAN ELSASSER, Salt Point, NY (US); Schuyler Mann, Poughkeepsie, NY (US); Daniel Ruiz, Cold Spring, NY (US)

(21) Appl. No.: 18/893,168

(22) Filed: Sep. 23, 2024

(51) Int. Cl. B25J 15/00

(52) U.S. Cl. CPC B25J 15/009

(57) ABSTRACT

Mechanical gripping of a component in an automated work environment can include positioning first and second moveable grippers in opposed relation to one another. Each of the first and the second moveable grippers including actuatable pins arranged in an array, and the arrays of actuable pins are in opposed relation to one another. The actuatable pins are movably attached to a backplate on each of the first and second moveable grippers to slide in an inward direction into apertures, respectively, in the backplate when compressed by an inward force. In response to the actuable pins contacting an object between the first and second moveable grippers when the first and second movable grippers are moved toward each other to grasp the object, the actuatable pins contacting the object depressing inwardly into the backplates on each of first and second moveable grippers, respectively.

### BACKGROUND

The present disclosure relates to automated mechanical grippers in a work or tool environment.

In one example, pick and place operations, which could be in a work or tooling environment, using robotic arms often deploy grippers that rely on frictional gripping methods to grasp an object. One issue with gripper such as these is that they do not effectively secure the object or component for assembly, with other parts or as part of an apparatus. For applications with complex or delicate components, custom grippers are typically required. However, customized grippers for each component in a pick and place operation adds complexity and cost to automation projects requiring assembly, and additionally limit the scope of what can be achieved with a single robotic arm. Existing solutions deploy linearly actuated mechanical grippers or pneumatic vacuum grippers that can be insufficient for delicate and complex components. One solution can include custom grippers designed for individual components. This can limit the scope of automation because the grippers are customized for one or similar components. Thus, customized grippers limit the space and capacity due to the unique gripper heads and can slow down cycle times by requiring gripper heads to be changed or swapped.

### SUMMARY

The present disclosure recognizes the shortcomings and problems associated with current techniques for mechanical grippers.

The present invention provides a solution for gripping different shaped items in a work environment which includes automated mechanical grippers, and more specifically automated mechanical grippers using a pin array.

The present invention solves identified problems with existing solutions by providing a gripper head that combines pneumatics and linear actuation into a flexible gripper that can pick up components of varying geometries, orientations, sizes, and materials. Pneumatics are used to provide a constant low air pressure to the back of plastic pins organized in a grid pattern that push the pins out of a sleeve in the absence of resistance. When the pin assembly encounters an object or component, the force on the front of the internal pin is greater than the air pressure on the back of the pin, forcing it inside the outer pin housing or sleeve and locking the pin assembly in place. With a tight grid of sufficiently small pins, this effectively creates a mold around the picked component. After all the pins have encountered a surface or an opposing pin in opposing grippers or gripper pads, all pins will be locked in place (e.g., where the gripper can maintain shape indefinitely). Once the object has been placed, constant vacuum pressure on the back of the pin grid can force all pins back out to a neutral rear position, which releases the object from the pins in a molded configuration.

In an aspect according to the present invention, a method for mechanical gripping of a component in an automated work environment includes positioning first and second moveable grippers in opposed relation to one another. Each of the first and the second moveable grippers including actuatable pins arranged in an array, and the arrays of actuable pins are in opposed relation to one another. The actuatable pins are movably attached to a backplate on each of the first and second moveable grippers to slide in an inward direction into apertures, respectively, in the backplate when compressed by an inward force. In response to a plurality of the actuable pins contacting an object between the first and second moveable grippers when the first and second movable grippers are moved toward each other to grasp the object, the actuatable pins contacting the object depressing inwardly into the backplates on each of first and second moveable grippers, respectively.

In a related aspect, the method further includes maintaining actuation of the actuatable pins in an outward direction from the backplates using a device communicating with the actuatable pins via the back plates, respectively.

In a related aspect, the device is a pneumatic device.

In a related aspect, the array of actuable pins are in a mesh configuration.

In a related aspect, the method can further include the actuatable pins of the first and second moveable grippers returning to an initial state of being actuated in the outward direction from the backplates, respectively, when the object is released from between the arrays of actuatable pins of the first and second moveable grippers.

In a related aspect, the method can further include connecting the first and second moveable grippers to arms, respectably, and the arms connecting to a tool. The tool is adapted to move the actuatable pins of the first and second movable grippers, respectively, toward and away from each other, such that the actuatable pins of the first and second moveable grippers are depressed inwardly when contacting the object when the first and second moveable grippers grasp the object therebetween.

In a related aspect, the first and second moveable grippers are rotatably connected to the arms.

In a related aspect, the method can further include the actuatable pins of the first and second moveable grippers returning to an initial state of actuated outwardly from the backplates on each of the first and second moveable grippers, respectively, when the object is released from between the arrays of actuatable pins of each of the first and second moveable grippers.

In a related aspect, the method further includes coupling the first and second moveable grippers via the arms to a tool, and the tool is configured to move the first and second moveable grippers toward each other. And the method includes coupling the tool to an articulated arm of a robotic device, and the articulated arm configured to position the first and second moveable grippers about the object with the arrays of pins engageable with the object.

In another aspect according to an embodiment of the present invention, an apparatus for automated gripping of a component in a work environment includes a first moveable gripper positioned opposite a second moveable gripper. Each of the first and the second moveable grippers including actuatable pins arranged in an array. The arrays of actuable pins are in opposed relation to one another, and the actuatable pins are movably attached to a backplate on each of the first and second moveable grippers to slide in an inward direction into respective apertures in the backplates when compressed by an inward force. The actuatable pins of the first moveable gripper are in opposed relation to the actuatable pins of the second moveable gripper. A device communicates with the actuatable pins via the back plates, and the device is adapted to maintain actuation of the actuatable pins in an outward direction from the backplates. The first and second moveable grippers are connected to arms, respectably, and the arms are connected to a tool. The tool is adapted to move the first and the second moveable grippers and the actuatable pins, respectively, toward and away from each other. The actuatable pins of the first and second moveable grippers are depressed inwardly when the first and second moveable grippers grasp an object therebetween.

In a related aspect, the grasping of an object between the first and second moveable grippers includes the arrays of actuable pins of each of the first and second moveable grippers contacting the object, and the actuable pins are depressed inwardly where the actuatable pins contact the object.

In a related aspect, the maintained actuation of the actuable pins in the outward direction is a selectable outward force provided by the device and applied to the actuable pins.

In a related aspect, the device is a pneumatic device.

In a related aspect, the first and second moveable grippers are rotatably connected to the arms.

In a related aspect, the array of actuable pins are in a mesh configuration.

In a related aspect, the apparatus further including the actuatable pins of the first and second moveable grippers returning to an initial state of being actuated in the outward direction from the backplates, respectively, when the object is released from between the arrays of actuatable pins of the first and second moveable grippers.

In a related aspect, the apparatus further including the tool being coupled to an articulated arm of a robotic device, and the articulated arm is configured to position the first and second moveable grippers about the object with the arrays of pins engageable with the object.

In another aspect according to another embodiment of the invention, a computer system for mechanical gripping of a component in an automated work environment includes a processor set, a computer-readable storage medium. Program instructions are stored on the computer-readable storage medium to cause the processor set to perform operations comprising moving first and second moveable grippers in opposed relation to one another towards one another. Each of the first and the second moveable grippers including actuatable pins arranged in an array. The arrays of actuable pins are in opposed relation to one another, and the actuatable pins are movably attached to a backplate on each of the first and second moveable grippers to slide in an inward direction into apertures, respectively, in the backplate when compressed by an inward force. In response to the actuable pins contacting an object between the first and second moveable grippers when the first and second movable grippers are moved toward each other to grasp the object, the actuatable pins contacting the object depressing inwardly into the backplates on each of first and second moveable grippers, respectively.

In a related aspect, the computer system further includes maintaining actuation of the actuatable pins in an outward direction from the backplates using a device communicating with the actuatable pins via the back plates, respectively.

In a related aspect, the computer system can further include the actuatable pins of the first and second moveable grippers returning to an initial state of being actuated in the outward direction from the backplates, respectively, when the object is released from between the arrays of actuatable pins of the first and second moveable grippers.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1A is a side elevational cross-sectional view of a pin and sleeve of a pin assembly for use with a gripper assembly according to an embodiment of the present disclosure.

FIG. 1B is a side elevational cross-sectional view of the pin assembly depicting pressure applied by a manifold.

FIG. 1C is a side elevational cross-sectional view of the pin assembly in a locked position.

FIG. 1D is a side elevational cross-sectional view of the pin assembly depicting a vacuum being applied in the manifold.

FIG. 2 is a side elevational cross-sectional view of a gripper, which includes the pin assembly, and a gripper housing, according to an embodiment of the present disclosure.

FIG. 3A is a side elevational cross-sectional view of a gripper apparatus, according to an embodiment of the present disclosure, including opposing grippers having pins retracted and not engaging a component.

FIG. 3AA is a detail cross-sectional view of the pin assembly shown in FIG. 3A, without shim plates engaged.

FIG. 3B is a side elevational cross-sectional view of the gripper apparatus shown in FIG. 3A, with the pins of each of opposing grippers engaging a component therebetween,

FIG. 3BA is a detail cross-sectional view of the pin assembly shown in FIG. 3B, with the shim plates engaged.

FIG. 3C is a detail cross-sectional view of the gripper apparatus shown in FIGS. 3A and 3B, with the component removed from between the opposing grippers and the pins of the grippers in a locked position.

FIG. 4 is a side cross-sectional elevational view of a gripper positioned horizontally with the pins in a vertical position.

FIG. 5 is a side elevational cross-sectional view of a gripper using electro-magnetic actuation.

FIG. 6 is an isometric view of an articulated robotic arm coupled to the gripper apparatus having opposing moveable grippers.

FIG. 6A is an isometric view of an array of pins connected to a back plate for coupling to a gripper, and depicting a person's hand depressing some of the pins in the pin array.

FIG. 7 is a flow chart depicting a method of manufacturing a mechanical gripping apparatus for gripping of components in an automated work environment.

FIG. 8 is a flow chart depicting a method for mechanical gripping of components in an automated work environment.

FIG. 9 is a schematic block diagram depicting a computer system according to an embodiment of the disclosure, which includes cloud computing components and functions, and which can cooperate with the one or more apparatuses, systems, and methods shown in the figures and described herein.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### Embodiments and Examples

Embodiments and figures of the present disclosure may have the same or similar components as other embodiments. Such figures and descriptions illustrate and explain further examples and embodiments according to the present disclosure. Embodiments of the present disclosure can include operational actions and/or procedures. A method, such as a computer-implemented method, can include a series of operational blocks for implementing an embodiment according to the present disclosure which can include cooperation with one or more systems shown in the figures. The operational blocks of the methods and systems according to the present disclosure can include techniques, mechanism, modules, and the like for implementing the functions of the operations in accordance with the present disclosure. Similar components may have the same reference numerals. Components can operate in concert with a computer implemented method. It is understood that a user can be a customer, an individual, or a group of individuals, or a company or an organization.

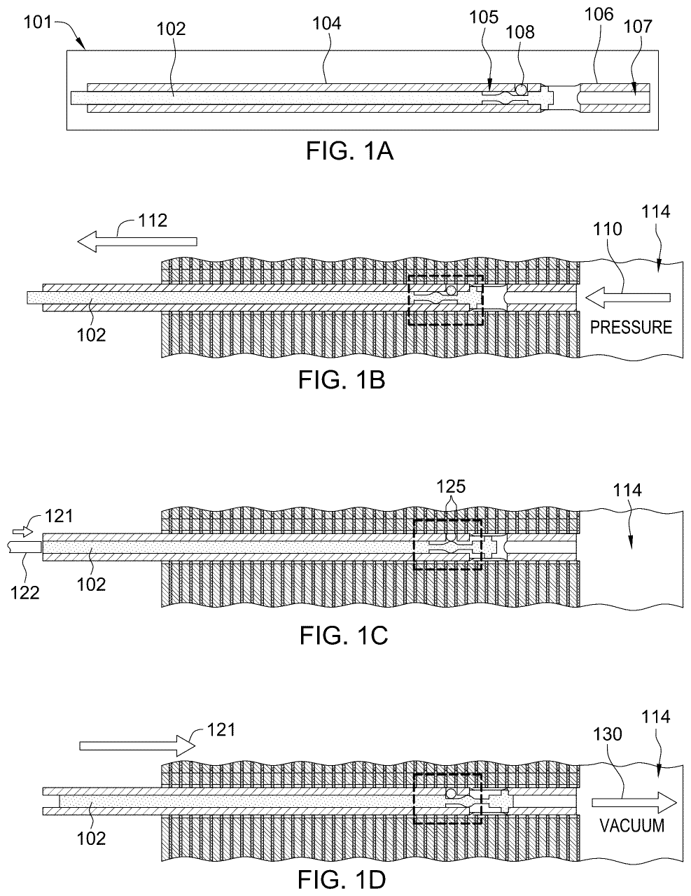

Referring to FIGS. 1A, 1B, 1C, and 1D, and in one embodiment according to the present disclosure, an apparatus for automated gripping of a component can include a pin assembly. The pin assembly 101 includes a movable pin 102 in a sleeve 104 defining an opening 105, as shown in FIG. 1A. The pin 102 includes a spherical element 108 for locking the pin in place along the sleeve. A housing 106 is in the rear of the pin assembly 101 and includes a housing opening 107 contiguous with the opening 105 defined by the sleeve 104.

Referring to FIG. 1B, the pin 102 moves in an outwardly direction 112 when pressure 110 is applied to the pin using a pressurized rear manifold 114. Using the pressurized rear manifold, the pin can move in a forward direction when the pin is unlocked.

Referring to FIG. 1C, an opposing geometry 122, which can be for example, an object, or a component, or a part or a piece of an object, can apply pressure in a return or backward direction 121 which pushes the pin 102 back or in a backwards direction. The rear manifold can be relieved of pressure, and thus is not pressurized. Internal shim plates 125 can be used to lock the spherical element 108, thus locking the pin in place or in a position. As the pin 102 moves back, a feature, e.g., a ridge, on the pin causes the spherical element 108 to engage between the shim plates 125, thus locking the pin assembly 101 in position.

Referring to FIG. 1D, a vacuum 130 can be generated in the rear manifold 114 which pulls the pin 102 in a backward direction 121 when the pin is unlocked.

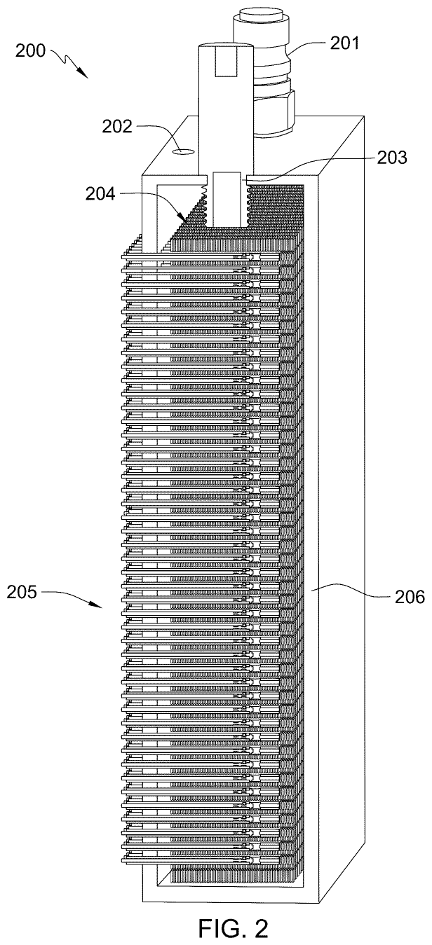

Referring to FIG. 2, and in one embodiment according to the present disclosure, an apparatus for automated gripping of a component can include a gripper or first moveable gripper 200. The gripper 200 includes a compressed air quick connect 201. The compressed air quick connect allows connection to compressed air hose that can be used to provide continuous low pressure to the inside of the gripper housing.

The gripper also includes a vacuum port 202. The vacuum port allows a connection to a vacuum line that can be used to provide continuous vacuum to the inside of the gripper housing. The gripper includes an adjustable pressure relief valve 203. The valve 203 maintains a constant pressure (which can be set by an operator) in the rear of a pin array such as a rear manifold, to ensure consistent pin actuation stiffness or outward pressure to the pins of the pin array.

The gripper includes a shim plate stack 204. The shim plate stack 204 provides alignment and locking surfaces for a pin assembly locking feature interface. The gripper also includes a pin array 205. The pin array linearly actuates in and out of the gripper to form a mold around a component which is picked and placed. The gripper includes a gripper housing 206. The gripper housing provides a chamber for the compressed air and organizes the pin array into the desired shape. Thus, the gripper housing is an enclosed cavity.

In operation, after a mold has been locked using a part, the gripper can be used as a go/no-go gage where parts that are picked are very close in geometry to the part. Delicate or flexible parts that should not experience high lateral loads do not need to compress the pin array for each pick if the mold is created on a rigid/throw-away part. Thereby, greater efficiency is provided for repetitive picks due to elimination of pin array compression actuation after each pick.

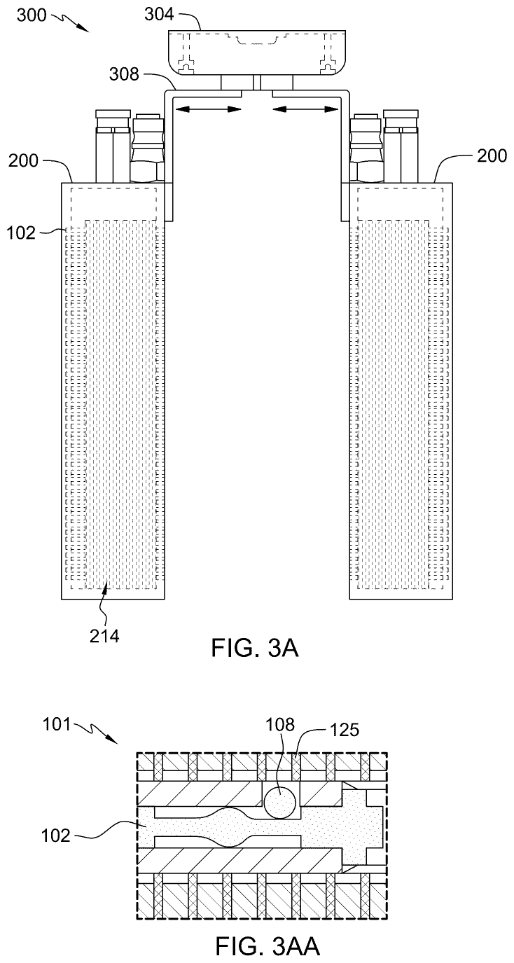

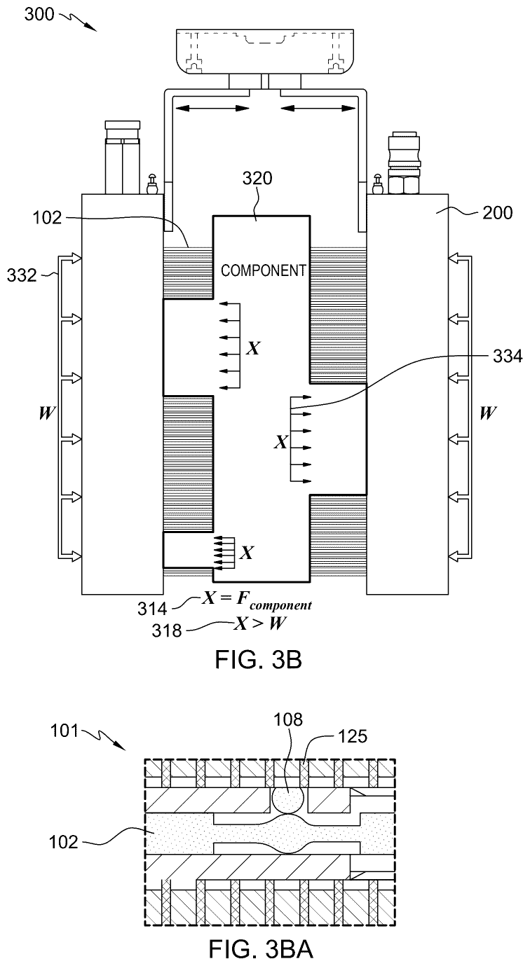

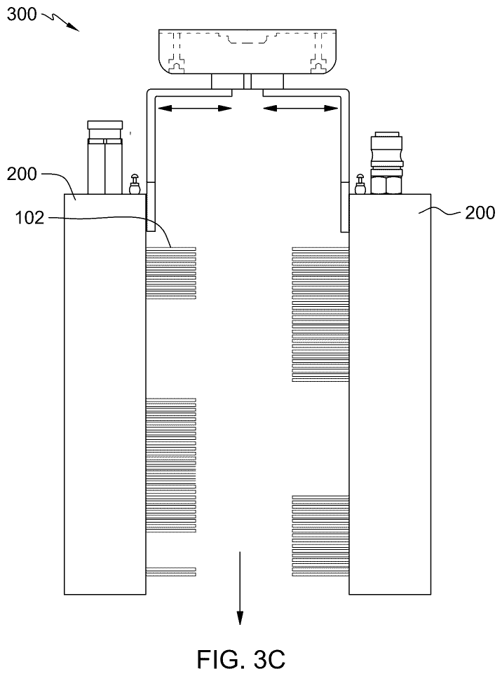

Referring to FIGS. 3A, 3B, and 3C, states of actuation of a gripper assembly 300 having two opposing grippers are shown. Referring to FIG. 3A, the gripper assembly 300 includes opposing grippers which include the first moveable gripper 200 and a second moveable gripper 200, in opposed relation to one another or mirror image relation to one another. It is understood that the grippers, or opposing grippers, are referring to first and second moveable grippers 200.

In FIG. 3A, the opposing grippers 200 are not gripping a component or without a component therebetween. Each of the grippers include pins 102 unlocked and in a retracted position. The gripper assembly 300 includes a housing 304 and moveable arms 308.

Referring to FIG. 3AA, a portion of the pin assembly 101 is depicted and shows the spherical element 108 not locked by the internal shim plates 125. Thus, the pin 102 is in an unlocked state.

Referring to FIG. 3B, the gripper assembly 300 includes the opposing grippers gripping a component 320 therebetween. The pins 102 are actuated in their extended positions. The pins 102 are also in a locked state (as shown in FIG. 3BA) in their extended positions. The equation 314 includes a variable x 334 which is equal to a F (force) component represented by x 334, in FIG. 3B. Equation 318 states that x 334 is greater than w 332 which represents an actuation force for each of the pins 102, whether individually or in an array. Thus, a force generated by the component 320 contacting the pins 102 when the pins are actuated and extending from the grippers, is greater than the force w generated to extend the pins from the grippers, and thus the pins retract into the gripper where in contact with the component, as shown in FIG. 3B.

Referring to FIG. 3BA, the portion of the pin assembly shown in FIG. 3AA is shown where the spherical element 108 is locked by internal shim plates 125. Thus, the pin is in a locked state and in a locked position.

Referring to FIG. 3C, the gripper assembly 300 includes the pins actuated and in a locked position as shown in FIG. 3B, however, the component is removed. The component can be removed, in one example, by moving the arms 308 connecting the grippers 200 away from each other while the pins are in a locked state.

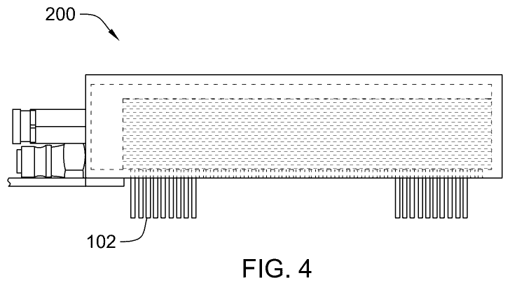

Referring to FIG. 4, in one example, the gripper 200 is shown in a horizontal position with some of the pins 102 in an actuated position extending vertically. In one example, when applied in the vertical direction, a negative or mold of a part with or without additional clamping methodologies can be created.

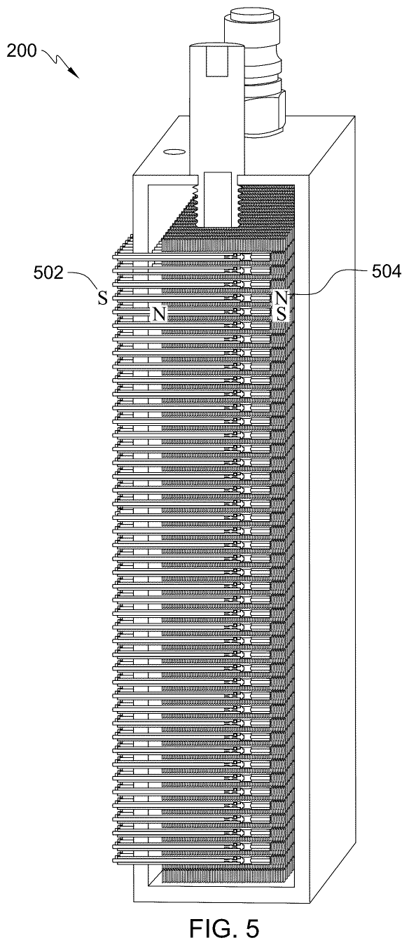

Referring to FIG. 5, in one example, the gripper 200 uses electro-magnetic actuation to actuate the pins. A south pole S 502 and a north pole N 504 refer to the two magnetic poles of a magnet. Opposite poles, N and S attract each other while like poles repel each other. Thus, magnetism can be used to actuate the pins outwardly from the gripper and retract the pins into the gripper. Thereby, localized electromagnetic forces attract ore repel magnetic pins instead of air pressure or a vacuum.

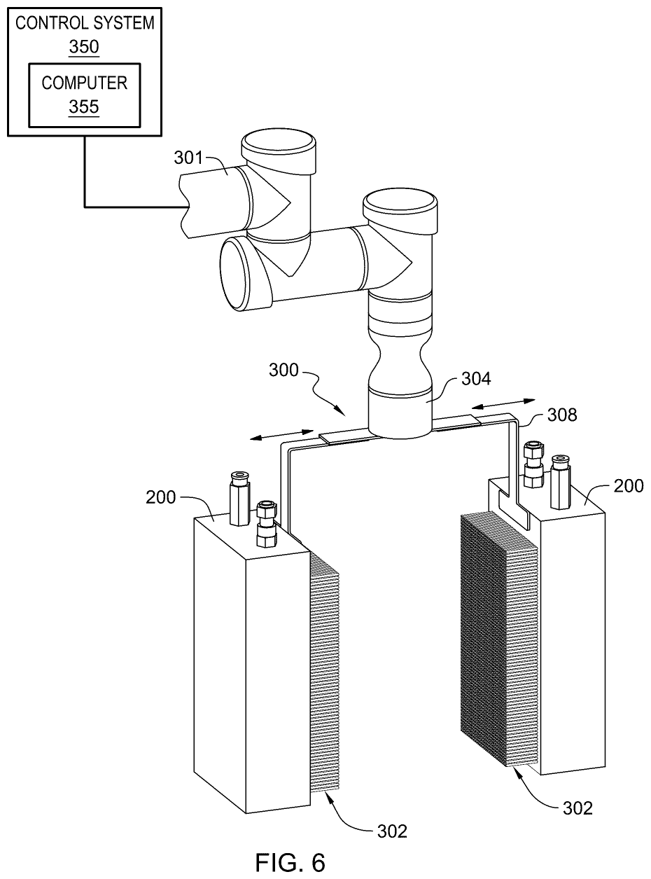

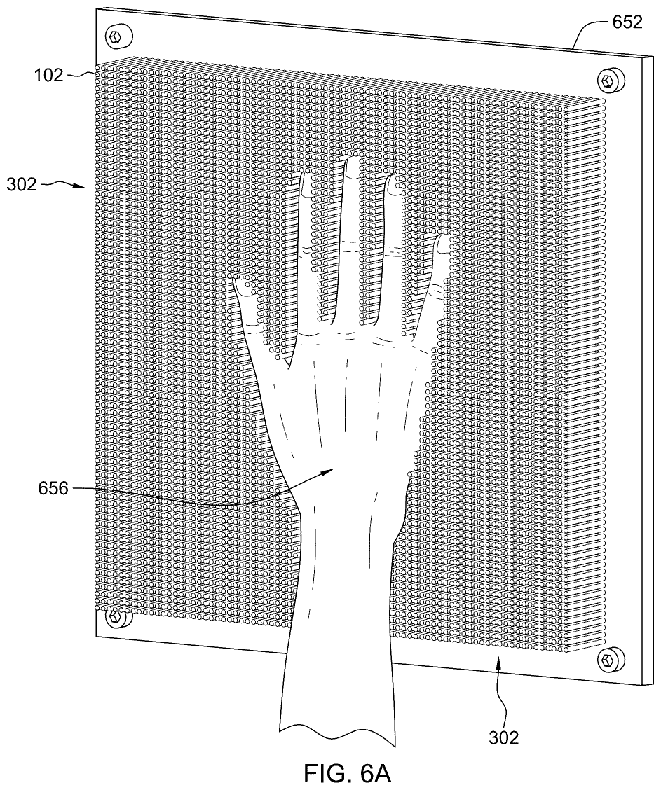

Referring to FIG. 6, in one embodiment according to the present disclosure, the gripper assembly 300 is coupled to an articulated robotic arm 301. The grippers 200 each include pin arrays 302 which include a plurality of the pins 102 in opposed relation to one another, respectively, regarding the opposed grippers.

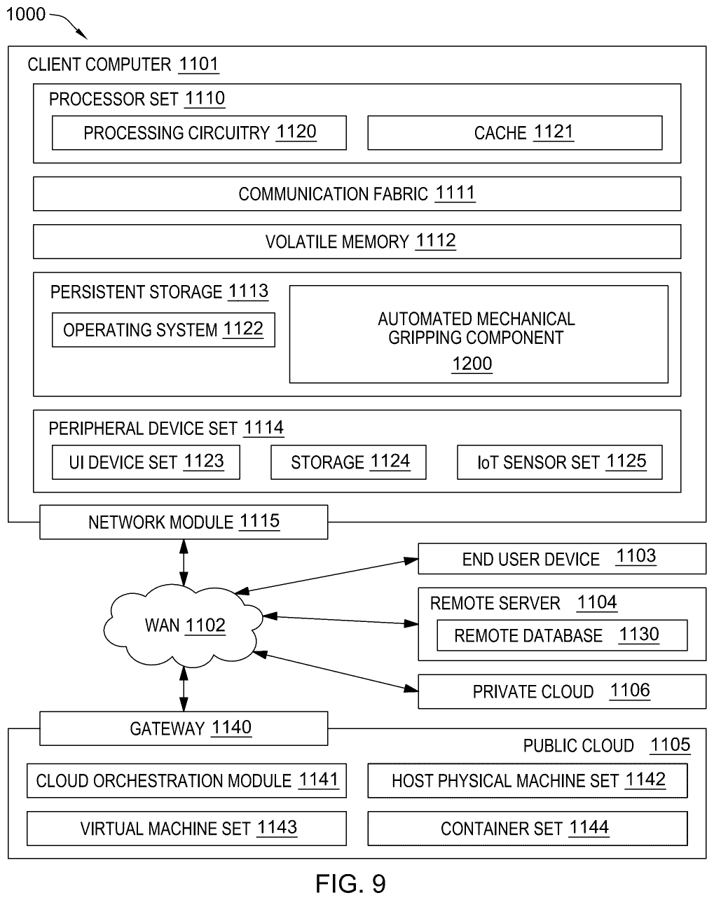

Referring to FIG. 6, in one example, the robotic arm can communicate or be communicably connected to a control system 350 which includes a computer 355. The control system can be used to control the robotic arm or as part of a robotic system. The computer can be a component of the control system or remote from the control system and communicating with the control system. Components of the computer 355 can include a computer readable medium, and a computer program, which is executable using a processor. Such a system, for example, is shown in FIG. 9 as computer 1101. In one example, the control system can communicate with remote systems via a communications network, for example, such as, for example, shown in FIG. 9 in the computer system 1000.

Referring to FIG. 6A, the pin array 302 shown in FIG. 6 is shown in more detail. The pin array 302 is attached to a back pad 652 which can be attached to the gripper 200. A person's hand 656, for example, is shown depressing pins 102 in the pin array 302 where the hand contacts the pins.

Thus, embodiments of the present disclosure, use a tool or mechanism, for example the gripper assembly 300, which can automatically locks/unlocks pins independent of their position within the actuation range. The internal pins can lock automatically upon encountering an object. A vacuum can simultaneously unlock and retract pins. The tool and/or mechanism of the present disclosure allows the same actuation method to achieve an unlimited number of unique actuation positions based on part or component geometry. Thus, the gripper assembly can autonomously modulate resistance given additional components to allow communication between a robot and the gripper assembly 300 or a gripper 200 itself. Using smart inlet and outlet valves, for example, vacuum port 202 and relief valve 203, the resistance of the gripper could be controlled without manual intervention. By connecting valves to a robots outputs, a user can modulate the gripper resistance in a robot program. By implementing a feedback system within the gripper or gripper assembly, the gripper or gripper assembly can modulate its own resistance based on pin displacement. Such operations can account for variations, ensure all pins lock via a feedback loop, and modulate actuation based on interactions between inner/outer pins (force, electrical, signal, pressure etc.).

Thereby, embodiment of the present disclosure can use a constant hydraulic/pneumatic pressure to actuate pins (e.g., linearly actuate pins) into a default position (which move freely with gravity). Embodiments also lock pins in a designated shape creating a mold capable of encompassing a part or component. Further, embodiments can scale resistance to a desired amount, and the pins can return to a default position. Also, embodiments can scale resistance of the actuated pins to a desired amount.

In one example, the articulated robotic arm 301 which is attached to the gripper assembly 300 can be coupled to a functioning robot. The gripper assembly can enhance automation projects by providing enhanced pick and place capabilities which are more efficient and thereby save time and energy of collaborative robots and automation projects. Such articulated arm, and gripper assembly as in embodiments presented herein used with robots can result in labor savings as well, and reliably pick and place parts with unique geometries.

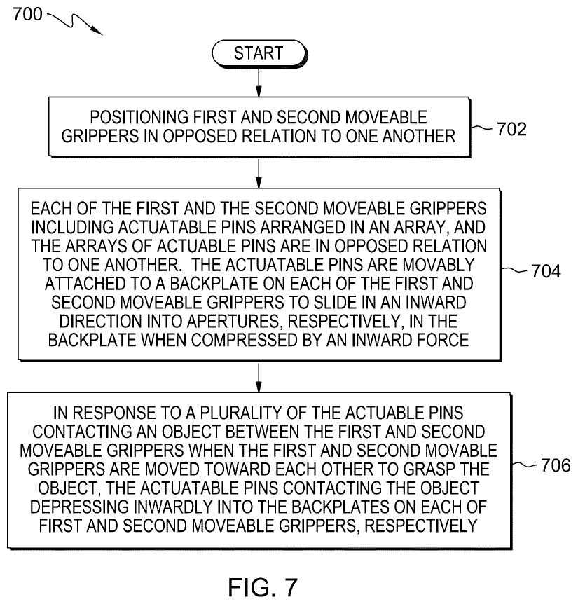

Referring to FIG. 7, according to one embodiment of the present disclosure, and with reference to FIGS. 3A and 3B as an example, a method 700 of manufacturing a mechanical apparatus for mechanical gripping of a component in an automated work environment can include positioning first and second moveable grippers 200 in opposed relation to one another, as in operation 702. Each of the first and the second moveable grippers can include actuatable pins 102 arranged in an array 302 (FIG. 6), and the arrays of actuable pins are in opposed relation to one another, as in operation 704. The actuatable pins are movably attached to a backplate on each of the first and second moveable grippers to slide in an inward direction into apertures, respectively, in the backplate when compressed by an inward force, as in operation 704.

In response to a plurality of the actuable pins 102 contacting an object or component 320 between the first and second moveable grippers 200 when the first and second movable grippers are moved toward each other to grasp the object, the actuatable pins contacting the object depressing inwardly into the backplates 214 on each of first and second moveable grippers, respectively, as in operation 706. The first and second moveable grippers grasp an object between them, thereby forming a mold around the object, as shown in FIGS. 3B and 3C.

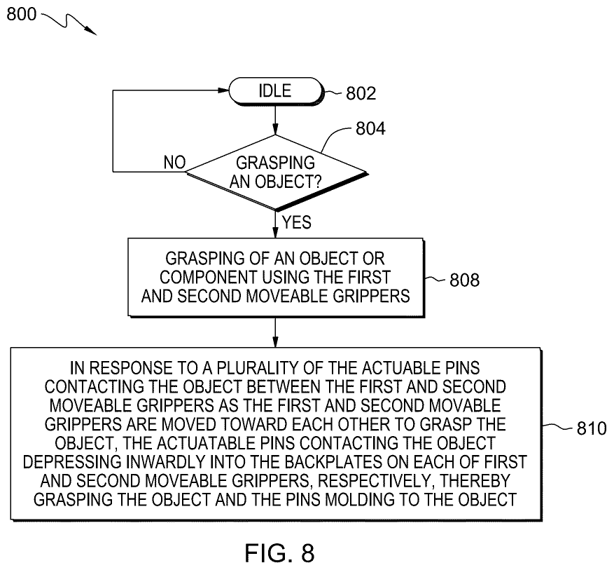

Referring to FIG. 8, in another example according to the present disclosure, a method 800 for gripping a component in an automated work environment includes the first and second moveable grippers 200 in an idle state, as in operation 802. When an operation does not initiate grasping an object, at operation 804, the method returns to operation 802 to remain idle. When an operation initiates grasping an object, at operation 804, the method proceeds to operation 808 which includes grasping of an object or component using the first and second moveable grippers.

In response to a plurality of the actuable pins 102 contacting the object or component 320 between the first and second moveable grippers 200 as the first and second movable grippers are moved toward each other to grasp the object, the actuatable pins contacting the object depressing inwardly into the backplates 214 on each of first and second moveable grippers 200, respectively, thereby grasping the object and the pins molding to the object, as in operation 810.

In one example according to the present disclosure, and as shown for example in various figures, the first and second moveable grippers 200 are attached to moveable arms 308 and a housing 304 via the moveable arms. The gripper assembly 300 can be coupled to a robotic arm 301 via the housing 304, and the robotic arm can be attached to a robot (not shown) or automatic device. Such a robot or automatic device can include manufacturing robots and automation and can include automation using a computer for operating instructions initiating and ceasing mechanical actions, as well as specific picking and placing instructions for the grippers. For example, the computer can be local to the robot or remote or several computers can be communicating and local and remote. Such remote computers can be part of a remote system including remote computers or a cloud-based system. Such a computer can all or in part be represented by the computer 1101 in FIG. 9, in a computing environment 100, which is discussed in more detail below.

In one example, the method can further include maintaining actuation of the actuatable pins in an outward direction from the backplates using a device communicating with the actuatable pins via the back plates, respectively.

In one example, the device is a pneumatic device.

In one example, the array of actuable pins are in a mesh configuration.

In one example, the method can further include the actuatable pins of the first and second moveable grippers returning to an initial state of being actuated in the outward direction or outwardly from the backplates, respectively, when the object is released from between the arrays of actuatable pins of the first and second moveable grippers.

In one example, the method can further include connecting the first and second moveable grippers to arms, respectably, and the arms connecting to a tool. The tool is adapted to move the actuatable pins of the first and second movable grippers, respectively, toward and away from each other, such that the actuatable pins of the first and second moveable grippers are depressed inwardly when contacting the object when the first and second moveable grippers grasp the object between them, thereby forming a mold around the object. Further, the actuatable pins of the first and second moveable grippers can return to an initial state of being actuated outwardly from the backplates, respectively, when the object is released from between the first and second moveable grippers.

In another example, the first and second moveable grippers are rotatably connected to the arms.

In another example, the method can further include the actuatable pins of the first and second moveable grippers returning to an initial state of actuated outwardly from the backplates on each of the first and second moveable grippers, respectively, when the object is released from between the arrays of actuatable pins of each of the first and second moveable grippers.

In another example, the method further includes coupling the first and second moveable grippers via the arms to a tool, and the tool is configured to move the first and second moveable grippers toward each other. The method includes coupling the tool to an articulated arm of a robotic device, and the articulated arm is configured to position the first and second moveable grippers about the object with the arrays of pins engageable with the object.

In another embodiment according to the present disclosure, and with reference to at least FIG. 3A, FIG. 3B, and FIG. 6 and FIG. 6A, an apparatus for automated gripping of a component in a work environment includes two grippers 200 in opposed relation or mirror image relation to one another which include a first moveable gripper positioned opposite a second moveable gripper. Each of the first and the second moveable grippers include actuatable pins 102 arranged in an array 302. The arrays of actuable pins are in opposed relation to one another, and can be in a mesh configuration. The actuatable pins are movably attached to a backplate 214 on each of the first and second moveable grippers to slide in an inward direction into respective apertures in the backplates when compressed by an inward force. The actuatable pins of the first moveable gripper are in opposed relation to the actuatable pins of the second moveable gripper.

A device (for example, a pneumatic device) can use the backplates on each of the grippers to communicate with the actuatable pins via the back plates. The device is adapted to maintain actuation of the actuatable pins in an outward direction from the backplates when in operation.

The first and second moveable grippers can be connected to arms, respectably, and the arms can be connected to a tool. The tool can be adapted to move the actuatable pins of the first and second movable grippers, respectively, toward and away from each other. The actuatable pins of the first and second moveable grippers are depressed inwardly when the first and second moveable grippers grasp an object between them. Thereby, the pins form a mold around the object. In one example the actuatable pins can remain in a fixed position depressed inwardly and the pin array forming a mold reflecting the shape of the object after the object or component is removed from between the grippers. In another example, the actuatable pins of the first and second moveable grippers return to an initial state of actuation outwardly from the backplates, respectively, when the object is released from between the first and second moveable grippers.

In one example, the grasping of an object between the first and second moveable grippers includes the arrays of actuable pins of each of the first and second moveable grippers contacting the object. The actuable pins are depressed inwardly where the actuatable pins contact the object.

In one example, the maintained actuation of the actuable pins in the outward direction is a selectable outward force provided by the device and applied to the actuable pins.

In another example, the device is a pneumatic device.

In another example, the first and second moveable grippers are rotatably connected to the arms.

In another example, the array of actuable pins are in a mesh configuration.

In another example, the apparatus further includes the actuatable pins of the first and second moveable grippers returning to an initial state of actuation in the outward direction or outwardly from the backplates, respectively, when the object is released from between the arrays of actuatable pins of the first and second moveable grippers.

In another example, the apparatus further includes the first and second moveable grippers coupled to a tool via the arms, and the tool configured to move the first and second moveable grippers toward each other. The tool is coupled to an articulated arm of a robotic device, and the articulated arm is configured to position the first and second moveable grippers about the object with the arrays of pins engageable with the object.

In another embodiment according to the present disclosure, a computer system for mechanical gripping of a component in an automated work environment can include a processor set, a computer-readable storage medium, and program instructions stored on the computer-readable storage medium to cause the processor set to perform operations as follows. The system includes moving first and second moveable grippers in opposed relation to one another towards one another. Each of the first and the second moveable grippers including actuatable pins arranged in an array, and the arrays of actuable pins are in opposed relation to one another. The actuatable pins are movably attached to a backplate on each of the first and second moveable grippers to slide in an inward direction into apertures, respectively, in the backplate when compressed by an inward force. In response to the actuable pins contacting an object between the first and second moveable grippers when the first and second movable grippers are moved toward each other to grasp the object, the actuatable pins contact the object and depress inwardly into the backplates on each of first and second moveable grippers, respectively.

The computer system can further include maintaining actuation of the actuatable pins in an outward direction from the backplates using a device communicating with the actuatable pins via the back plates, respectively.

The computer system can further include the actuatable pins of the first and second moveable grippers returning to an initial state of actuated in the outward direction or outwardly from the backplates, respectively, when the object is released from between the arrays of actuatable pins of the first and second moveable grippers.

In another embodiment according to the present disclosure, a method for mechanical gripping of a component in an automated work environment can include the following operations. The method can include moving first and second moveable grippers towards one another. Each of the first and the second moveable grippers including actuatable pins arranged in an array, and the arrays of actuatable pins being in opposed relation to one another. The actuatable pins are movably attached to a backplate on each of the first and second moveable grippers to slide in an inward direction into apertures, respectively, in the backplate when compressed by an inward force. The method further includes, in response to the actuatable pins contacting an object between the first and second moveable grippers when the first and second movable grippers are moved toward each other to grasp the object, the actuatable pins contacting the object depressing inwardly into the backplates on each of first and second moveable grippers, respectively. Thus, when the first and second moveable grippers grasp an object between them, a mold is formed around the object.

In another embodiment according to the present disclosure, a computer program product for mechanical gripping of a component in an automated work environment which can include a computer readable storage medium having program instructions embodied therewith to perform the following operations. The computer program product includes program instruction to move first and second moveable grippers in opposed relation to one another towards one another. Each of the first and the second moveable grippers including actuatable pins arranged in an array, and the arrays of actuable pins are in opposed relation to one another. The actuatable pins are movably attached to a backplate on each of the first and second moveable grippers to slide in an inward direction into apertures, respectively, in the backplate when compressed by an inward force. The computer program product includes program instructions to, in response to the actuable pins contacting an object between the first and second moveable grippers when the first and second movable grippers are moved toward each other to grasp the object, the actuatable pins contacting the object are depressed inwardly into the backplates on each of first and second moveable grippers, respectively.

In another embodiment according to the present disclosure, a system for automated gripping of a component in a work environment can include a first moveable gripper positioned opposite a second moveable gripper. Each of the first and the second moveable grippers including actuatable pins arranged in an array, and the arrays of actuable pins are in opposed relation to one another, and can be in a mesh configuration. The actuatable pins are movably attached to a backplate on each of the first and second moveable grippers to slide in an inward direction into respective apertures in the backplates when compressed by an inward force. The actuatable pins of the first moveable gripper are in opposed relation to the actuatable pins of the second moveable gripper.

The system includes a device (for example a pneumatic device) which can use the back plates to communicate with the actuatable pins. The device is adapted to maintain actuation of the actuatable pins in an outward direction from the backplates. The first and second moveable grippers are connected to arms, respectably, and the arms are connected to a tool.

The tool is adapted to move the actuatable pins of the first and second movable grippers, respectively, toward and away from each other, and the actuatable pins of the first and second moveable grippers are depressed inwardly when the first and second moveable grippers grasp an object between them. Thereby, a mold around the object is formed. In one example, the object can be removed while the pins are locked in position thereby the pins retain the mold of the object after the object is removed. The actuatable pins of the first and second moveable grippers can return to an initial state of being actuated outwardly from the backplates, respectively, when the object is released from between the first and second moveable grippers.

The system can include an articulated arm of a robotic device coupled to the tool. The articulated arm is configured to position the first and second moveable grippers about the object with the arrays of pins engageable with the object.

Thereby, embodiments according to the present disclosure, can include an apparatus for gripping components and is deployed as a universal mechanical gripper. The gripper can include a first moveable gripper positioned opposing a second moveable gripper. Each of the first and the second grippers include a plurality of actuatable pins in a mesh configuration, and the pins are movably attached to a backplate to slide in respective apertures in the backplate when compressed by an inward force. A device (for example, a pneumatic device) uses the back plates to communicate with the actuatable pins. The device is adapted to maintain actuation of the actuatable pins in an outward direction from the backplate when in operation, and the actuatable pins of the first moveable gripper are in opposed relation to the actuatable pins of the second moveable gripper. The first and second moveable grippers are rotatably connected to arms, respectably, and the arms are connected to a tool. The tool is adapted to move the first and second movable grippers toward and away from each other, and the actuatable pins of the first and second moveable grippers are depressed when the first and second moveable grippers grasp an object between them, thereby forming a mold around the object. The actuatable pins of the first and second moveable grippers can return to an initial state of actuated outwardly from the backplates, respectively, when the object is released from between the first and second moveable grippers.

In another embodiments of the present disclosure, a method or system for gripping components can include moving first and second movable grippers toward each other such that actuatable pins of the first and second moveable grippers are depressed when the first and second moveable grippers grasp an object between them, thereby forming a mold around the object. And the actuatable pins of the first and second moveable grippers can return to an initial state of being actuated outwardly from respective backplates, when the object is released from between the first and second moveable grippers.

In other embodiments and examples, in the present disclosure shown in the figures, a computer can be part of a remote computer or a remote server, for example, a remote server. In another example, the computer can be part of a control system and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs. A device(s), for example a mobile device or mobile phone, can belong to one or more users, and can be in communication with the control system via the communications network.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the device can include a computer having a processor and a storage medium which stores an application, and the computer includes a display. The application can incorporate program instructions for executing the features of the present disclosure using the processor. In another example, the mobile device application or computer software can have program instructions executable for a front end of a software application incorporating the features of the method of the present disclosure in program instructions, while a back end program or programs, of the software application, stored on the computer of the control system communicates with the mobile device computer and executes other features of the method. The control system and the device (e.g., mobile device or computer) can communicate using a communications network, for example, the Internet.

In one example, a system according to the present disclosure can include a control system communicating with a device via a communications network. The control system can incorporate all or part of an application or software for implementing the method of the present disclosure. The control system can include a computer readable storage medium where account data and/or registration data can be stored. User profiles can be part of the account data and stored on the storage medium. The control system can include a computer having computer readable storage medium and software programs stored therein. A processor can be used to execute or implement the instructions of the software program. The control system can also include a database.

It is also understood that methods and systems according to embodiments of the present disclosure, can be incorporated into (Artificial Intelligence) AI devices, components or be part of an AI system, which can communicate with respective AI systems and components, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

### More Examples and Embodiments

Additionally, methods and systems according to embodiments of the present disclosure can be discussed in relation to a functional system(s) depicted by functional block diagrams. The methods and systems can include components and operations for embodiments according to the present disclosure, and is used herein for reference when describing the operational steps of the methods and systems of the present disclosure. Additionally, the functional system, according to an embodiment of the present disclosure, depicts functional operations indicative of the embodiments discussed herein.

It is understood that the features shown in some of the figures, for example block diagrams, are functional representations of features of the present disclosure. Such features are shown in embodiments of the systems and methods of the present disclosure for illustrative purposes to clarify the functionality of features of the present disclosure.

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is also understood that the one or more computers or computer systems shown in the figures can include all or part of a computing environment and its components shown in another figure, for example, the computing environment 1000 can be incorporated or cooperate, in all or in part, in a system having one or more computers or devices, which may be shown in other figures and described herein. In one example, the one or more computers can communicate with all or part of a computing environment and its components as a remote computer system to achieve computer functions described in the present disclosure.

### More Additional Examples and Embodiments

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 9, a computing environment 1000 contains an example of an environment for the execution of at least some of the computer code involved in performing the inventive methods, such as using a computer for automated mechanical gripping of a component 1200. In addition to block 1200, computing environment 1000 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1101, to keep the presentation as simple as possible. Computer 1101 may be located in a cloud, even though it is not shown in a cloud in FIG. 7. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1000, at least some of the instructions for performing the inventive methods may be stored in block 1200 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

What is claimed is:

1. A method for mechanical gripping of a component in an automated work environment, comprising:
positioning first and second moveable grippers in opposed relation to one another, each of the first and the second moveable grippers including actuatable pins arranged in an array, and the arrays of actuable pins being in opposed relation to one another, and the actuatable pins being movably attached to a backplate on each of the first and the second moveable grippers to slide in an inward direction into apertures, respectively, in the backplate when compressed by an inward force; and
in response to a plurality of the actuable pins contacting an object between the first and second moveable grippers when the first and second movable grippers are moved toward each other to grasp the object, the actuatable pins contacting the object depressing inwardly into the backplates on each of first and second moveable grippers, respectively.

2. The method of claim 1, further comprising:
maintaining actuation of the actuatable pins in an outward direction from the backplates using a device communicating with the actuatable pins via the back plates, respectively.

3. The method of claim 2, wherein the device is a pneumatic device.

4. The method of claim 1, wherein the array of actuable pins are in a mesh configuration.

5. The method of claim 1, further comprising:
the actuatable pins of the first and second moveable grippers returning to an initial state of being actuated in an outward direction from the backplates, respectively, when the object is released from between the arrays of actuatable pins of the first and second moveable grippers.

6. The method of claim 1, further comprising:
connecting the first and second moveable grippers to arms, respectably, and the arms connecting to a tool, the tool being adapted to move the actuatable pins of the first and second movable grippers, respectively, toward and away from each other, such that the actuatable pins of the first and second moveable grippers are depressed inwardly when contacting the object when the first and second moveable grippers grasp the object therebetween.

7. The method of claim 1, wherein the first and second moveable grippers are rotatably connected to the arms.

8. The method of claim 1, further comprising:
the actuatable pins of the first and second moveable grippers returning to an initial state of being actuated outwardly from the backplates on each of the first and second moveable grippers, respectively, when the object is released from between the arrays of actuatable pins of each of the first and second moveable grippers.

9. The method of claim 1, further comprising:
coupling the first and second moveable grippers via the arms to a tool, and the tool being configured to move the first and second moveable grippers toward each other; and
coupling the tool to an articulated arm of a robotic device, the articulated arm being configured to position the first and second moveable grippers about the object with the arrays of pins engageable with the object.

10. An apparatus for automated gripping of a component in a work environment, which comprises:
a first moveable gripper positioned opposite a second moveable gripper, each of the first and the second moveable grippers including actuatable pins arranged in an array, the arrays of actuable pins being in opposed relation to one another, the actuatable pins being movably attached to a backplate on each of the first and second moveable grippers to slide in an inward direction into respective apertures in the backplates when compressed by an inward force, the actuatable pins of the first moveable gripper being in opposed relation to the actuatable pins of the second moveable gripper;
a device communicates with the actuatable pins via the back plates, the device adapted to maintain actuation of the actuatable pins in an outward direction from the backplates; and
the first and second moveable grippers being connected to arms, respectably, and the arms being connected to a tool, the tool being adapted to move the first and the second moveable grippers and the actuatable pins, respectively, toward and away from each other, and the actuatable pins of the first and second moveable grippers being depressed inwardly when the first and second moveable grippers grasp an object therebetween.

11. The apparatus of claim 10, wherein the grasping of an object between the first and second moveable grippers includes the arrays of actuable pins of each of the first and second moveable grippers contacting the object and the actuable pins being depressed inwardly where the actuatable pins contact the object.

12. The apparatus of claim 10, wherein the maintained actuation of the actuable pins in the outward direction being a selectable outward force provided by the device and applied to the actuable pins.

13. The apparatus of claim 10, wherein the device is a pneumatic device.

14. The apparatus of claim 10, wherein the first and second moveable grippers are rotatably connected to the arms.

15. The apparatus of claim 10, wherein the array of actuable pins are in a mesh configuration.

16. The apparatus of claim 10, further comprising:
the actuatable pins of the first and second moveable grippers returning to an initial state of being actuated in the outward direction from the backplates, respectively, when the object is released from between the arrays of actuatable pins of the first and second moveable grippers.

17. The apparatus of claim 10, further comprising:
the tool being coupled to an articulated arm of a robotic device, the articulated arm being configured to position the first and second moveable grippers about the object with the arrays of pins engageable with the object.

18. A computer system for mechanical gripping of a component in an automated work environment, comprising:
a processor set, a computer-readable storage medium, and program instructions stored on the computer-readable storage medium to cause the processor set to perform operations comprising:
moving first and second moveable grippers in opposed relation to one another towards one another, each of the first and the second moveable grippers including actuatable pins arranged in an array, and the arrays of actuable pins being in opposed relation to one another, and the actuatable pins being movably attached to a backplate on each of the first and second moveable grippers to slide in an inward direction into apertures, respectively, in the backplate when compressed by an inward force; and
in response to the actuable pins contacting an object between the first and second moveable grippers when the first and second movable grippers are moved toward each other to grasp the object, the actuatable pins contacting the object depressing inwardly into the backplates on each of first and second moveable grippers, respectively.

19. The computer system of claim 18, further comprising:
maintaining actuation of the actuatable pins in an outward direction from the backplates using a device communicating with the actuatable pins via the back plates, respectively.

20. The computer system of claim 18, further comprising:
the actuatable pins of the first and second moveable grippers returning to an initial state of being actuated in the outward direction from the backplates, respectively, when the object is released from between the arrays of actuatable pins of the first and second moveable grippers.
